(19) United States
(12) Patent Application Publication
(10) Pub. No.: US 2009/0032138 A1
(43) Pub. Date: Feb. 5, 2009

(54) Vacuum attachment for rotary tool

(75) Inventors: Markus Alleman, Grayslake, IL (US); Edward G. Ennis, Niles, IL (US); Jose Nieto, Chicago, IL (US); Adam W. Rollo, Fareham (GB)

Correspondence Address: MAGINOT, MOORE & BECK, LLP;CHASE TOWER, 111 MONUMENT CIRCLE, SUITE 3250, INDIANAPOLIS, IN, 46204, US

(73) Assignee: Credo Technology Corporation, Broadview, IL (US)

(21) Appl. No.: 11/890,039

(22) Filed: Aug. 3, 2007

(51) Int. Cl. B27G 19/00

(52) U.S. Cl. 144/252.1

(57) ABSTRACT

An attachment device for a rotary tool having an output shaft extending from the rotary tool housing is disclosed herein. The attachment device comprises an attachment housing defining a vacuum mouth. A fastening member is coupled to the attachment housing, and is configured to releasably connect the attachment housing to the tool housing. A fan is retained within the attachment housing. The fan is configured for connection to the end of the output shaft extending from the rotary tool such that rotation of the output shaft results in rotation of the impeller. Rotation of the impeller causes air and debris to be drawn into the attachment through the mouth. A debris container is coupled to the attachment housing and is configured to receive the debris drawn into the housing through the vacuum mouth.

### FIELD

This application relates to the field of rotary power tools, and particularly to attachment devices for hand-held rotary tools.

### BACKGROUND

Power tools are widely used in the modern world. Of these, the rotary tool is a favorite of professional craftsmen, handymen, homeowners and hobbyists. A rotary tool is a handheld power tool with a variety of rotating accessory bits and attachments that can be used for cutting, carving, sanding, polishing and many other applications. One example of a rotary tool is the DREMEL® rotary tool sold by Robert Bosch Corporation.

An exemplary rotary tool is shown in FIG. 4. The rotary tool 10 includes a housing 94 that easily fits in a human hand. An output shaft 96 extends from a threaded end 98 of the housing 94. The output shaft 96 is connected to a motor retained in the housing 94. The motor is capable of rotating at a high speed. A collet nut 90 engages a collet on the end of the output shaft 96. The collet nut 90 and collet are designed to retain a tool “bit” or “burr” on the end of the output shaft 96. The tool bit allows the rotary tool to perform various functions such as, for example, drilling, grinding, sharpening, cutting, cleaning, polishing, sanding, routing, carving and engraving, depending upon the attachment. Some exemplary attachments allow the rotary tool to be used as a miniature planar, circular saw, or saber saw.

Rotary tools typically operate at high revolutions per minute (RPMs) to maintain the correct cutting conditions for the tool bits. The tools also have low torque which makes them safer for freehand use than the larger higher powered power tools. The high rotational speed of the tool allows it to perform work effectively. Some rotary tools are variable-speed versions operable over a wide range of RPMs, e.g., 5,000-35,000 RPM.

Many jobs performed with rotary tools create a significant amount of dust, shavings, or other debris that must be cleaned up by the user. A user may utilize a shop vacuum or a household vacuum to perform clean up tasks. For a large mess, the user may not think twice about using a shop vacuum or household vacuum. However, for smaller messes, the process of retrieving a large shop vacuum or household vacuum and bringing it to the work area may seem very inconvenient. Accordingly, it would be desirable to provide a means for assisting the user in cleaning up relatively small messes without the need to retrieve a shop vacuum or household vacuum.

Because the rotary tool is configured for use with various attachments, it would be desirable to provide an attachment for the tool that could assist the user with clean up. It would be advantageous if such an attachment were relatively small and could be located in close proximity of the rotary tool on a user's workbench. It would also be advantageous if such attachment could be provided to the user as a single component that easily attaches to the user's rotary tool.

As set forth above, it would be desirable to provide a rotary tool that provides one or more of the above-mentioned advantages as may be apparent to those reviewing this disclosure. However, the teachings disclosed herein extend to those embodiments which fall within the scope of the appended claims, regardless of whether they accomplish one or more of the above-mentioned advantages.

### SUMMARY

An attachment device for a rotary tool having an output shaft extending from the rotary tool housing is disclosed herein. The attachment device comprises an attachment housing defining a vacuum mouth. A fastening member is coupled to the attachment housing, and is configured to releasably connect the attachment housing to the tool housing. In at least one embodiment, the fastening member is a threaded overthrow nut configured to engage complimentary threads on the end of the rotary tool housing.

A fan in the form of an impeller is retained within the attachment housing. The impeller is configured for connection to the end of the output shaft extending from the rotary tool such that rotation of the output shaft results in rotation of the impeller. When the attachment is connected to the housing of the rotary tool, the end of the output shaft extending from the tool housing is positioned within the attachment housing and engages a drive shaft for the impeller. Rotation of the impeller causes air and debris to be drawn into the attachment through the mouth. A debris container is coupled to the attachment housing. The debris container is configured to receive the debris drawn into the housing through the vacuum mouth. A filter is positioned in the attachment housing between the fan and the vacuum mouth to filter large debris from passing to the impeller and to the debris container.

The above described features and advantages, as well as others, will become more readily apparent to those of ordinary skill in the art by reference to the following detailed description and accompanying drawings.

### BRIEF DESCRIPTION OF THE DRAWINGS

FIG. 1 shows a perspective view of a vacuum attachment for a rotary tool;

FIG. 2 shows a cutaway perspective view of the vacuum attachment of FIG. 1;

FIG. 3 shows an exploded isometric view of the vacuum attachment of FIG. 1; and

FIG. 4 shows an exemplary rotary tool for use with the vacuum attachment of FIG. 1.

### DESCRIPTION

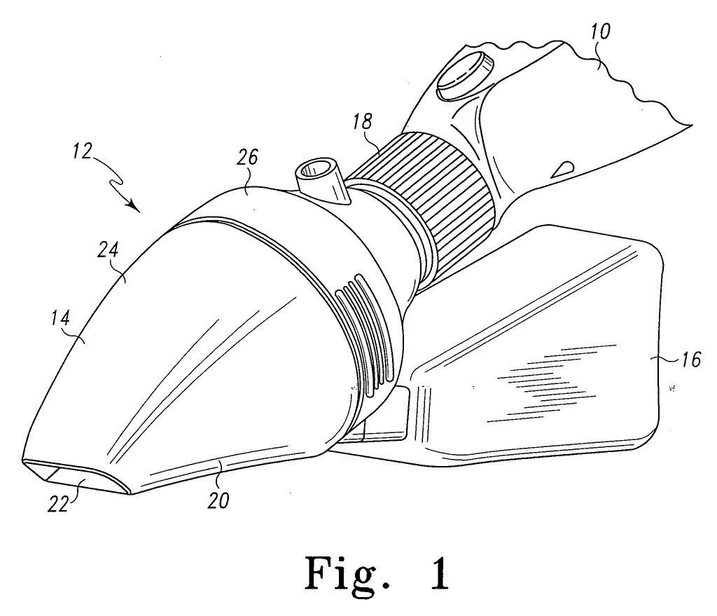

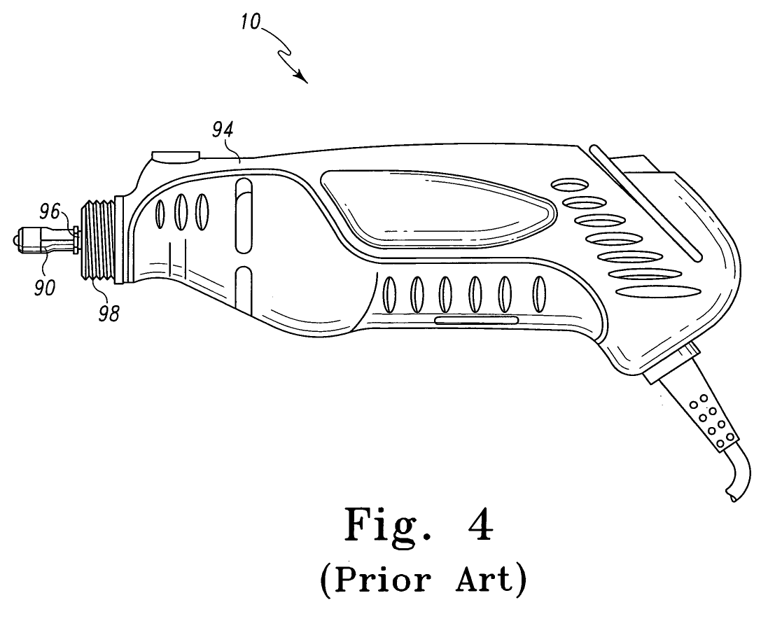

With reference to FIG. 1, a vacuum attachment 12 for a rotary tool 10 comprises a vacuum head 14, a debris container 16, and a coupling member 18 for releasably connecting the vacuum attachment to a rotary tool 10. The rotary tool 10 includes an output shaft 96 (see FIG. 4) that couples to driven components of the vacuum attachment 12. The output shaft 96 of the rotary tool 10 provides rotary motion that powers the driven components of the vacuum attachment 12. Dust and debris are received into the head 14 of the vacuum attachment through a vacuum mouth 22 formed in the head 14. The dust and debris received in the head 14 are then channeled to the debris container 16. The debris container 16 may be removed from the head 14, allowing the user to conveniently dispose of the contents of the container 16.

The head 14 of the vacuum attachment 12 includes an outer housing 20 and interior components 50 mounted within the housing. The housing 20 includes a forward member 24 and a rear member 26. The forward member 24 is somewhat cone shaped with a curving central axis. The vacuum mouth 22 is provided at the front tip of the forward member 24. The vacuum mouth 22 is designed and dimensioned to receive dust and relatively small bits of debris. Accordingly, in one embodiment, the area of the opening provided by the vacuum mouth is 2 in² or less. An exemplary dimension for the mouth 22 may be an opening of 2 inches by 1 inch.

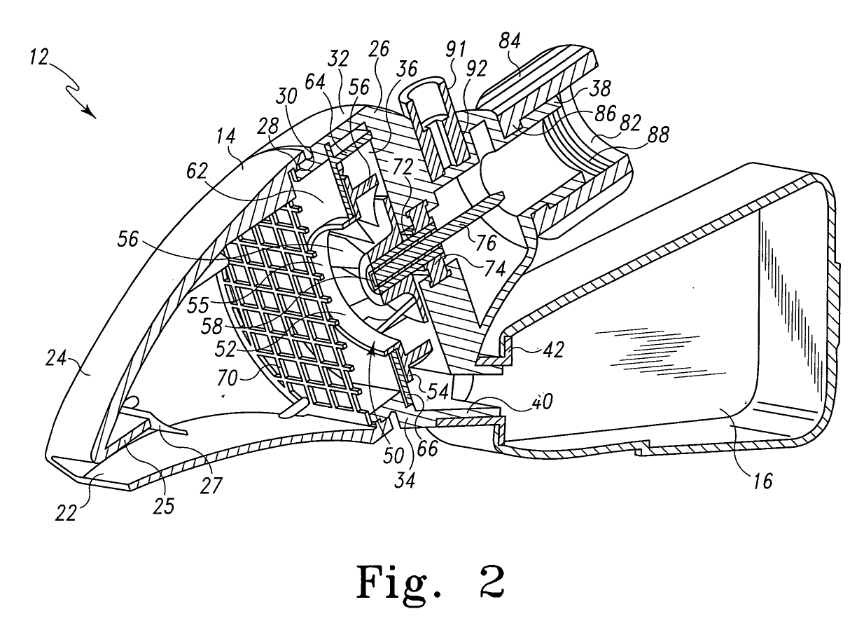

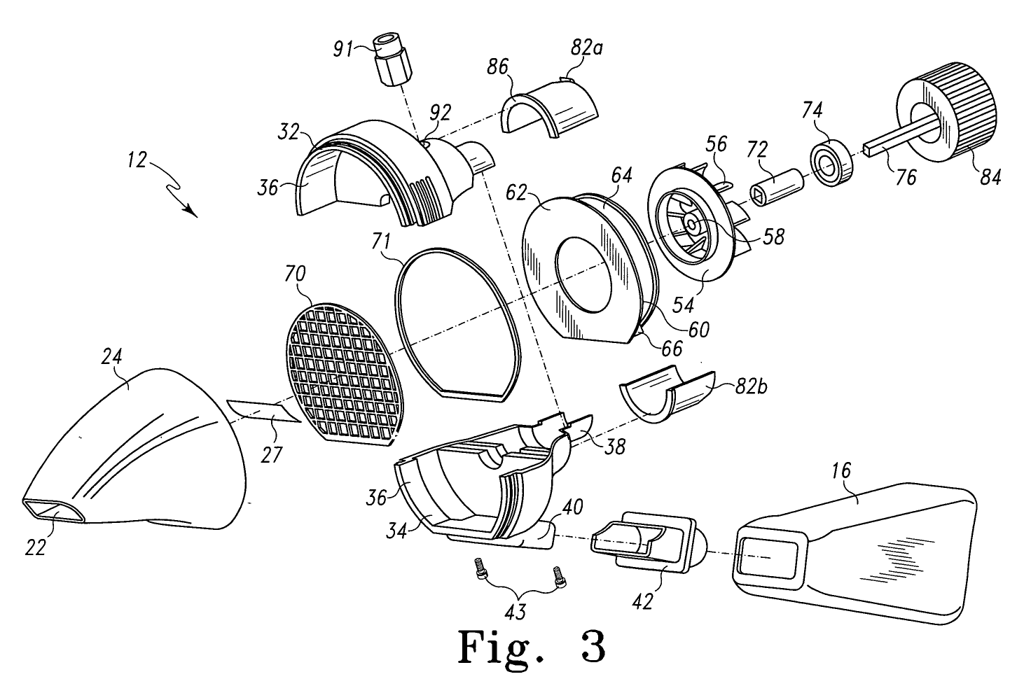

With reference now to FIGS. 2 and 3, an interior extending flange 25 is formed at the mouth 22 of the housing 20. The flange 25 is provided to hold a non-return valve 27 which is pivotably mounted on the flange 25. In the disclosed embodiment, the non-return valve 27 is provided as a curved plate of relatively rigid plastic dimensioned slightly larger than the mouth 22. The plate 27 is allowed to pivot inward toward the center of the head 14, providing an opening for debris to enter the head through the mouth 22 when air is drawn into the housing. When air is not drawn into the housing, the plate 27 is biased to pivot back toward the mouth 22 until an edge of the plate 27 contacts the surface of the housing 20. After the plate 27 contacts the surface of the housing 20, the passage from the mouth 22 to the interior portion of the head 14 is blocked by the plate 27. Accordingly, the pivotable plate 27 provides a non-return valve 27 allowing air and debris to enter the housing, but blocking air and debris from being discharged back out of the mouth 22.

The forward member 24 of the housing 20 engages the rear member 26 of the housing in a snap fit. Accordingly, raised internal rib segments 28 are provided around a rear rim of the housing's forward member 24. These rib segments 28 are configured to engage a circumferential groove 30 provided around a forward rim of the housing's rear member 26. For orientation purposes, the bottom portions of both the forward member and the rear member are flat. This snap fit coupling allows the user to connect the forward member 24 to the rear member 26 by forcing the two parts 24 and 26 together. To remove the forward member 24 from the rear member 26, the two parts 24 and 26 are pulled apart to release the snap fit coupling.

The rear member 26 of the housing is provided in two pieces, including an upper member 32 and a lower member 34. The upper member 32 and lower member 34 join together to provide an enlarged impeller cavity 36 and a smaller neck 38. The impeller cavity 36 includes various slots designed to receive the interior components 50 of the vacuum attachment 12.

The lower member 34 of the housing includes a discharge port 40. Air and debris drawn into the housing are channeled out of the housing and into the debris container 16 through the discharge port 40. A coupler 42 is connected to the discharge port 40 using fastening members, such as screws 43 (see FIG. 3). The coupler 42 is provided to allow the debris container 16 to be easily coupled to the discharge port 40. In the disclosed embodiment, the coupler 42 clips to the debris container and slides over outward extending walls of the discharge port 40. The debris container may be a unitary piece, such as a rigid plastic container, or may be provided as a multiple piece arrangement, such as a relatively rigid frame which holds a flexible bag member.

Air and debris are drawn into the head 14 and blown out the discharge port 40 using a fan 52 mounted within the head 14. In the disclosed embodiment, the fan is provided as an impeller 52 comprising a radial disc 54, a forward extending ring 55, a plurality of impeller blades 56, and a hub 58. The impeller 52 is received within a volute 60 but does not physically contact the volute 60. Accordingly, the impeller 52 is allowed to rotate within the volute 60.

The volute 60 is mounted in the impeller cavity 36 of the rear member 26 of the housing 20. The volute 60 includes a face 62 which is directed toward the mouth 22 and a sidewall 64 that extends back toward the neck 38. An outlet port 66 is provided near the lower portion of the volute 60. The outlet port 66 provides a funnel-shaped member of increasing area near the outer edge of the outlet port 66. The flat lower edge of the outlet port 66 contacts the discharge port 40 of the housing 20.

In front of the volute 60 is a filter 70 provided in the form of a mesh screen 70. The screen 70 is retained within a slot in the forward member 24 of the housing. An 0-ring 71 provides a seal for the filter 70 against the housing 20. Access to the screen 70 may be obtained when the forward member 24 of the housing is removed from the rear member 26. The screen 70 blocks large particles that could damage the impeller 52 from passing through to the impeller, while allowing smaller particles to pass on to the impeller 52 and through the head 14.

An impeller shaft 72 is connected to the impeller 52. A first end of the impeller shaft 72 is positioned in the hub 58 of the impeller 52 and the opposite end of the impeller shaft 74 is supported by a contact seal bearing 74. The contact seal bearing 72 is mounted in a slot of the rear member 26 of the housing. A drive shaft 76 is fixedly connected to the impeller shaft 72 through a central channel of the impeller shaft 72. The drive shaft 76 extends from the hub 58 of the impeller, through the bearing 74, and back to the neck 38 of the housing 20. Rotation of the drive shaft 76 imparts rotation to the impeller shaft 72 and the connected impeller 52.

The neck 38 of the housing 20 is configured to join to the end of the rotary tool 10 using a fastening member 80. The fastening member 80 comprises a two-piece overthrow nut 82, including half 82a and half 82b, and a sleeve 84. The two-piece overthrow nut 82 is designed to fit over the neck 38 of the housing 20. In particular, a semi-circular lip 86 is formed on both halves 82a and 82b of the overthrow nut 82. These semi-circular lips 86 fit into an annular slot around the neck 38. When the two halves 82a and 82b of the overthrow nut 82 are joined together, threads 88 are formed that are designed to engage complimentary threads on the end of a rotary tool 10.

The two halves 82a and 82b are secured together by the sleeve 84 which fits over the two halves of the overthrow nut 82. The sleeve 84 includes grooves or other locking features which mate with complimentary features on the overthrow nut 82 to lock the sleeve 84 on the overthrow nut 82. With the sleeve 84 locked to the overthrow nut, rotation of the sleeve 84 results in rotation of the overthrow nut 82. Accordingly, when the threaded end 98 of a rotary tool 10 is brought into engagement with the overthrow nut 82, the sleeve 84 is rotated to bring the threads 88 on the overthrow nut 82 into engagement with the complimentary threads 98 on the rotary tool 10.

An additional feature provided on the rear member 26 of the housing is a seat 92 for a drive nut 91 of the rotary tool 10. The drive nut 91 is configured for connection to the end of the drive shaft 76 to facilitate joining the drive shaft 76 to the output shaft 96 of the rotary tool 10. The seat 92 in the housing 20 provides a convenient location to hold the drive nut 91 while the vacuum attachment 12 is not in use.

In operation, the vacuum attachment 12 is connected to the rotary tool when the user wishes to vacuum dust, dirt, or other debris from a space. To accomplish this, the user first removes the drive nut 91 from the seat 92 of the housing 20 and joins the drive nut 91 to the drive shaft 76. In particular, a rectangular inner channel of the drive nut is placed over the rectangular end of the drive shaft 76. The user then inserts the output shaft 96 of the rotary tool 10 into the neck 38 of the housing, bringing the output shaft 96 of the rotary tool 10 into engagement with the drive nut 91 of the vacuum attachment 12. As will be recognized by those of skill in the art, a quick coupling arrangement may be provided between the output shaft 96 of the rotary tool 10 and the drive nut 91 of the vacuum attachment. One such quick coupling arrangement involves a flat head on the drive nut 91 and a complimentary slot to receive the flat head on the output shaft 96 of the rotary tool. It will be recognized by those of skill in the art that numerous other quick-connect arrangements are possible.

With the output shaft 96 of the rotary tool 10 inserted into the neck 38 of the vacuum attachment 12, the user rotates the sleeve 84 causing the threads 88 of the overthrow nut 82 to engage the threads on the end 98 of the rotary tool 10. When the overthrow nut 82 is tightened on the rotary tool 10, the output shaft of the rotary tool 10 engages the drive shaft 76 of the vacuum attachment such that rotation of the rotary tool's output shaft results in rotation of the vacuum attachment drive shaft 76.

With the vacuum attachment 12 secured to the rotary tool 10, the user turns the tool on, resulting in rotation of the tool's output shaft. Rotary motion from the tool is transmitted to the attachment drive shaft 76, the connected impeller drive shaft 72, and the impeller 52. When the impeller 52 rotates, the blades 56 of the impeller 52 move the surrounding air, creating a pressure differential, and drawing air and debris into the head 14 of the vacuum attachment 12. Large debris is filtered by the screen 70. Smaller debris passes on to the impeller 52 and volute 60, where it is directed to the outlet port 66. Debris in the outlet port 66 is blown through the connected discharge port 40 by the impeller and into the debris container 16.

After vacuuming an amount of debris, the user may remove the debris container 16 and dispose of the debris. In addition, the forward member 24 of the housing 20 may be pulled away from the rear member 26, thus providing access to the filter 70. The filter may then be pulled out of the forward member 24, and large debris stuck in the filter may be removed. The forward member 24 is then re-connected to the rear member 26. The entire vacuum attachment 12 may be removed from the rotary tool 10 by counter-rotation of the sleeve 84. After removing the attachment 12 from the tool 10, the drive nut 91 may then be removed from the drive shaft 76 and returned to the seat 92 on the housing 20 for storage of the drive nut 91 when the vacuum attachment 12 is not in use.

Although the present invention has been described with respect to certain preferred embodiments, it will be appreciated by those of skill in the art that other implementations and adaptations are possible. Moreover, there are advantages to individual advancements described herein that may be obtained without incorporating other aspects described above. Therefore, the spirit and scope of the appended claims should not be limited to the description of the preferred embodiments contained herein.

What is claimed is

1. An attachment device for a rotary tool including an output shaft extending from a rotary tool housing, the attachment device comprising:
a) an attachment housing defining a vacuum mouth;
b) a fastening member coupled to the attachment housing, the fastening member configured to releasably connect the attachment housing to the tool housing;
c) a fan retained within the attachment housing, the fan configured for connection to the end of the output shaft extending from the rotary tool such that rotation of the output shaft results in rotation of the fan; and
d) a debris container coupled to the attachment housing, the debris container configured to receive debris received into the housing through the vacuum mouth.

2. The attachment device of claim 1 further comprising a filter positioned in the attachment housing between the fan and the vacuum mouth.

3. The attachment device of claim 1 wherein the fan is an impeller.

4. The attachment device of claim 1 wherein rotation of the fan within the attachment housing is configured to generate a pressure differential sufficient to draw debris into the attachment housing.

5. The attachment device of claim I wherein the debris container comprises a bag.

6. The attachment device of claim 1 wherein the fastening member comprises a sleeve configured to threadedly engage the tool housing.

7. The attachment device of claim 1 wherein the end of the output shaft extending from the tool housing is positioned within the attachment housing when the attachment housing is connected to the tool housing.

8. The attachment device of claim 1 further comprising a non-return valve positioned in the attachment housing between the fan and the vacuum mouth.

9. The attachment device of claim 1 wherein the attachment housing comprises a drive nut seat configured to receive a drive nut removed from the end of the output shaft.

10. An attachment device for a rotary tool including an output shaft extending from a rotary tool housing, the attachment device comprising:
a) an attachment housing defining a vacuum mouth;
b) a fan retained within the attachment housing, the fan configured for releasable connection to the end of the output shaft, wherein rotation of the output shaft results in rotation of the fan when the fan is connected to the output shaft, and rotation of the fan draws air into the attachment housing through the vacuum mouth;
c) an outlet formed in the attachment housing, wherein air drawn into the attachment housing is directed out of the attachment housing through the outlet; and
d) a debris container connected to the outlet.

11. The attachment device of claim 10 wherein the attachment housing is coupled to the tool housing.

12. The attachment device of claim 10 further comprising a non-return valve positioned within the attachment housing between the vacuum mouth and the fan.

13. The attachment device of claim 10 further comprising a pre-filter positioned within the attachment housing between the vacuum mouth and the fan.

14. The attachment device of claim 10 further comprising a volute positioned within the attachment housing, wherein the volute includes a discharge port connected to the outlet formed in the attachment housing.

15. The attachment device of claim 14 wherein the fan comprises an impeller positioned at least partially within the volute.

16. The attachment device of claim 10 wherein the debris container comprises a dust bag connected to the outlet with a bag coupling.

17. A rotary tool attachment for a rotary tool having a rotary tool housing and an output shaft with an end of the output shaft extending from the rotary tool housing, the rotary tool attachment comprising:
a) an attachment housing comprising a vacuum mouth;
b) means for releasably coupling the attachment housing to the rotary tool housing such that the attachment housing covers the end of the output shaft extending from the rotary tool housing; and
c) means for drawing air and debris into the attachment housing through the vacuum mouth; and
d) means for retaining debris coupled to the attachment housing.

18. The rotary tool attachment of claim 17 further comprising means for filtering large debris drawn into the attachment housing from passing through the attachment housing and into the means for retaining debris.

19. The rotary tool attachment of claim 17 further comprising a means provided adjacent to the vacuum mouth for blocking air from passing out of the attachment housing through the vacuum mouth while allowing air to enter the attachment housing through the vacuum mouth.

20. The rotary tool attachment of claim 17 further comprising means for storing on the attachment housing a drive nut configured to engage the output shaft of the rotary tool.
